(19) United States
(12) Patent Application Publication
(10) Pub. No.: US 2008/0049033 A1
(43) Pub. Date: Feb. 28, 2008

(54) Computer Graphics System and Method Thereof

(76) Inventor: Shu-Kai Yang, Jhonghe City (TW)

Correspondence Address: LAW OFFICES OF LAI AND ASSOCIATES, P.C., 5800 RANCHESTER STE 200, HOUSTON, TX, 77036, US

(21) Appl. No.: 11/554,545

(22) Filed: Oct. 30, 2006

(30) Foreign Application Priority Data
Aug. 23, 2006 (TW) 095131010

(51) Int. Cl. G06F 13/18

(52) U.S. Cl. 345/535

(57) ABSTRACT

A computer graphics system and method thereof comprise a graphics data computation unit, a memory unit and an arbitrator. The graphics data computation unit is for receiving geometry data and a rendering parameter to generate intermediate data and output pixel data corresponding to the geometry data. The memory unit is for storing the intermediate data and the rendering parameter. The arbitrator is for determining whether the intermediate data stored in the memory unit can replace the currently to-be-computed intermediate data or not.

### FIELD OF THE INVENTION

The present invention relates to a computer graphics system and method thereof, and more particularly to computer graphics system and method integrated with an arbitrator.

### BACKGROUND OF THE INVENTION

With the increasing application of multimedia technology to the education and entertainment, there has been a trend in recent years to developing three-dimensional graphics technology Three-dimensional graphics technology needs much more computation than two-dimensional graphics technology, so the conventional application performs in work station or personal computer. With the increasing of handheld electronic apparatus, three-dimensional graphics technology is integrated gradually into the handheld electronic apparatus in recent years. However, the handheld electronic apparatus is usually implemented by simpler hardware and can not provide enough computation for three-dimensional graphics technology Besides, the power consuming of three-dimensional graphics technology is too large for handheld electronic apparatus to work in a long time.

What is needed is a computer graphics system that not only has modest performance but also needs low computation and low power consuming.

### SUMMARY OF THE INVENTION

The primary objective of the present invention is to provide a computer graphics system and method for reducing computing and power consuming of computer graphics.

The present invention provides a computer graphics system comprising a graphics data computing unit, a memory unit and an arbitrator. The graphics data computing unit is configured to receive a geometry data and a rendering parameter for generating at least one intermediate data and outputting at least one pixel data corresponding to the geometry data. The memory unit is configured to store the intermediate data and the rendering parameter. The arbitrator is configured to determine whether the currently to-be-computed intermediate data can be replaced by the intermediate data stored in the memory unit.

In one preferred embodiment of the present invention, the intermediate data is a transformed geometry data. The arbitrator is a transformation-matrix comparer that examines the similarity of the current matrix and the stored one. It is to avoid the unnecessary geometry-transformation computation.

In another preferred embodiment of the present invention, the intermediate data is a lighted data. The arbitrator comprises a light-vector calculator and comparer and examines the relationship of the geometry and the light source. It is to avoid the unnecessary lighting computation.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a block diagram of a computer graphics system in accordance with the present invention;

FIG. 2 is a block diagram of an embodiment of a computer graphics system in accordance with the present invention;

FIG. 3 is a flow chart of an embodiment of a computer graphics method in accordance with the present invention.

### DETAILED DESCRIPTION OF THE PREFERRED EMBODIMENTS

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

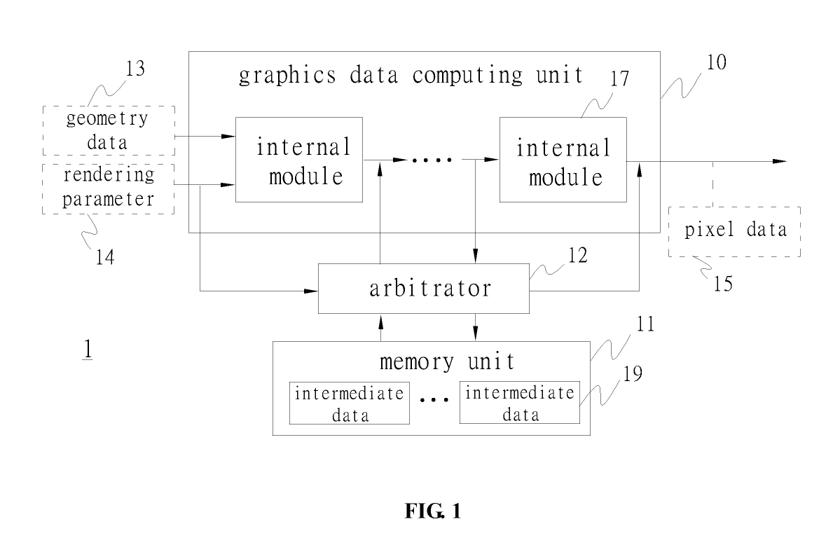

Referring to FIG. 1 for a block diagram of a computer graphics system in accordance with the present invention, a computer graphics system 1 comprises a graphics data computing unit 10, a memory unit 11 and an arbitrator 12. The graphics data computing unit 10 is configured to receive a geometry data 13 and a rendering parameter 14, the graphics data computing unit 10 generates at least one intermediate data 19 and outputs at least one pixel data 15 corresponding to the geometry data 13. The intermediate data 19 is a data generated by at least one internal module 17 of the graphics data computing unit 10. For example, the intermediate data 19 can be a coordinate-transformed geometry data or a lighted data.

The memory unit 11 is configured to store the intermediate data and the rendering parameter. The arbitrator 12 is configured to determine whether the currently to-be-computed intermediate data can be replaced by the intermediate data stored in the memory unit, if yes, the intermediate data 19 stored in the memory unit 11 is set as the output data of the internal 17 by the arbitrator 12 and send to next internal module; Otherwise, the internal module 17 performs the computation of this intermediate data. By above mention, the computation of the graphics data computing unit 10 can be reduced.

The internal module 17 can be a coordinate transformation module, a lighting computing module or a rasterization module and the intermediate data can be a transformed geometry data output from the coordinate transformation module, a lighted data output from the lighting computing module, or a pixel data output from the rasterization module.

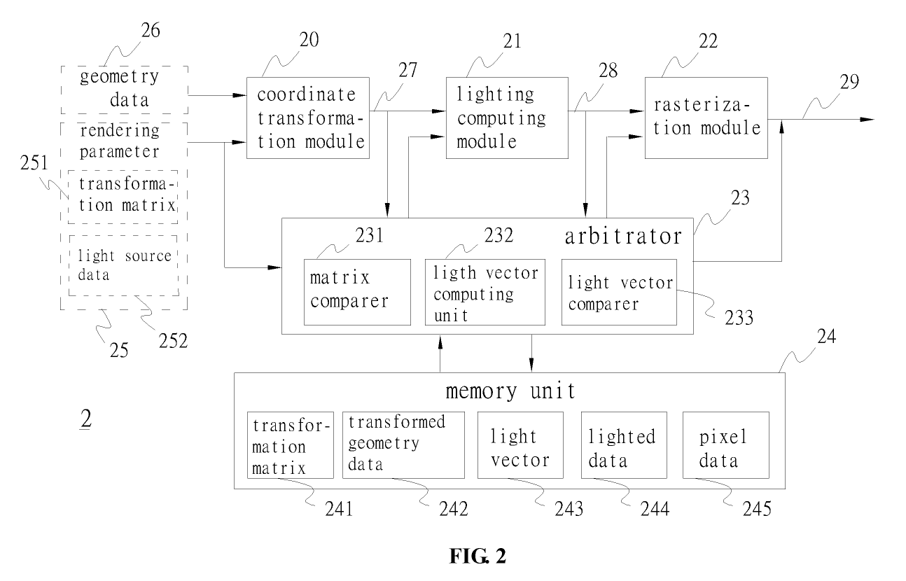

Referring to FIG. 2 for a block diagram of an embodiment of a computer graphics system in accordance with the present invention. A computer graphics system 2 comprises a coordinate transformation module 20, a lighting computing module 21, a rasterization module 22, an arbitrator 23 and a memory unit 24. The coordinate transformation module 20 is used to receive a rendering parameter 25 including a transformation matrix and a geometry data 26 and transform the geometry data 26 to a transformed geometry data 27 according to the transformation matrix. The geometry data 26 is a primitive vertex-buffer object, and the transformed geometry data 27 is a coordinate data of the vertex represented in a display coordinate system. The arbitrator 27 comprises a matrix comparer for determining whether a current transformation matrix 251 of the currently inputted rendering parameter 25 approximate to the transformation matrix 241 stored in the memory unit 24 or not. If yes, the transformed geometry data 242 stored in the memory unit 24 is valid so that operation of the coordinate transformation module 20 can be bypassed and the arbitrator 27 sets the transformed geometry data 242 stored in the memory unit 24 to be the output data of the coordinate transformation module 20 and replace currently to-be-computed transformed geometry data. If no, the coordinate transformation module 20 transforms an inputted geometry data to a transformed geometry data 27 based on the transformation matrix 251 of a currently inputted rendering parameter 25 and stores the transformation matrix 251 and the transformed geometry data 27 in the memory unit 24. By the above-mentioned process, the computation of the coordinate transformation module 20 can be reduced.

The matrix comparer has better to be a logical operator for performing a XOR operation on the currently inputted transformation matrix 251 and the transformation matrix 241 stored in the memory unit 24 to a result matrix, and performing an OR operation on elements of the result matrix. The currently inputted transformation matrix 251 is equal to the transformation matrix 241 stored in the memory unit 24 if the result of OR operation is zero.

Lighting computing module 21 is used to compute a lighted data 28 corresponding to the geometry data 28 based on the transformed geometry data 27 and a light source data 252. Lighting computation is used to simulate the lighting effect based on the light source data 252 and a lighted angle of the vertex. The lighted data is used to represent the color after the vertex is lighted. The arbitrator 23 comprises a light vector computing unit 232 for computing a light vector 243 between a light source and a representative vertex. The light vector 243 represents the relative direction and location relationship of the light source and the representative vertex. When the transformed geometry data 27 is ready to be inputted to the lighting computing module 21, light vector computing unit 232 computes a light vector of the transformed geometry data 27, and a light vector 243 of the transformed geometry data 242 stored in the memory unit 24 first, and then light vector comparer 233 performs a XOR operation on these two light vectors and performs an OR operation on results of the XOR operation. If the result of OR operation is zero, these two light vector are equal and the lighted data 244 stored in the memory unit 24 is valid so that the computation of the lighting computing module can be bypassed. If the result of OR operation is not equal to zero, the lighting computing module 21 computes a lighted data 28 based on the inputted transformation geometry data 27 and the light source data 252 and stores the lighted data 28 in the memory unit 24. By the above-mentioned process, the computation of the lighting computing module 21 can be reduced.

The rasterization module 22 is configured to generate at least one pixel data 29 based on the rendering parameter 25, transformed geometry data 27 and lighted data 28. The arbitrator 23 determines whether the pixel data need to be updated or not based on the comparison results of the matrix comparer 231 and light vector comparer 233. If both the results of the matrix comparer 231 and light vector comparer 233 are the equality or the approximation, the pixel data stored in the memory unit 24 is set as the output of the rasterization module 22. If one of the results of the matrix comparer 231 and light vector comparer 233 is not the equality or the approximation, the rasterization module computes and outputs at least one pixel data 29 based on the rendering parameter 25, transformed geometry data 27 and lighted data 28, and stores the pixel data 29 in the memory unit 24.

The memory unit 24 can includes a decoder for decoding a color data encoded by a discrete cosine transformation or other encoding transformation and loading to the lighted data 244 applied to a static geometry data, the relative location relationship between object and light source is fixed. The color data for static geometry data will not change in a period, so the color data can be pre-computed and encoded and stored in the memory unit 24. Besides, the arbitrator 23 can include an image filter. During rendering process, the image filter is used to filter a re-rendered image area and only output a pixel data of the updated area in the re-rendered image area to display for reducing the data transmission between the computer graphics system and the display.

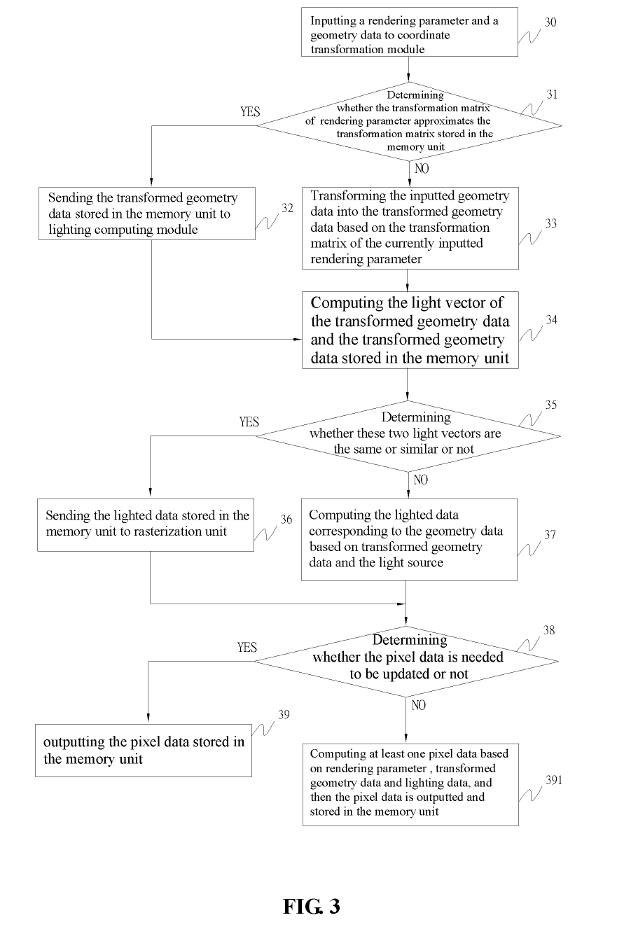

Referring to the FIG. 3 for a flow chart of an embodiment of a computer graphics method in accordance with the present invention, this embodiment corresponding to the computer graphics system 2 shown in FIG. 2 comprises the following steps:

Step 30: Inputting a rendering parameter 25 and a geometry data 26 to coordinate transformation module 20;

Step 31: Using matrix comparer 231 to determine whether the transformation matrix 241 of currently inputted rendering parameter 25 approximates the transformation matrix 241 stored in the memory unit 24, if yes, Step 32 is performed, if no, Step 33 is performed;

Step 32: Sending the transformed geometry data 242 stored in the memory unit 24 to lighting computing module 21;

Step 33: Using the coordinate transformation module 20 to transform the inputted geometry data 26 to the transformed geometry data 27 based on the transformation matrix 251 of the currently inputted rendering parameter 25, and then the transformed geometry data 27 and the transformation matrix 251 are stored in the memory unit 24 and the transformed geometry data 27 is sent to lighting computing module 21;

Step 34: Using the light vector computing unit 232 to compute the light vector of the transformed geometry data 27 and the transformed geometry data 242 stored in the memory unit 24;

Step 35: Using the light vector comparer 233 to determine whether these two light vectors are the same or similar or not, if yes, Step 36 is performed, if no, Step 37 is performed;

Step 36: Sending the lighted data 244 stored in the memory unit 24 to rasterization unit 22;

Step 37: Using the lighting computing module 21 to compute the lighted data 28 corresponding to the geometry data 26 based on transformed geometry data 27 and the light source data 252;

Step 38: Determining whether the pixel data is needed to be updated or not based on the comparison results of matrix comparer 231 and light vector comparer 233, if yes, Step 39 is performed, if no, Step 391 is performed;

Step 39: outputting the pixel data 245 stored in the memory unit 24;

Step 391: Using the rasterization module 22 to compute at least one pixel data 29 based on rendering parameter 25, transformed geometry data 27 and lighted data 28, and then the pixel data 29 is outputted and stored in the memory unit 24.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

What is claimed is:

1. A computer graphics system, comprising:
a graphics data computing unit configured to receive a geometry data and a rendering parameter for generating at least one intermediate data and outputting at least one pixel data corresponding to said geometry data;
a memory unit configured to store said intermediate data and said rendering parameter;
an arbitrator configured to determine whether said currently to-be-computed intermediate data can be replaced by said intermediate data stored in said memory unit or not.

2. The computer graphics system according to claim 1, wherein said rendering parameter includes a transformation matrix, and said graphics data computing unit has a coordinate transformation module for transforming said geometry to a transformed geometry data as said intermediate data based on said transformation matrix.

3. The computer graphics system according to claim 2, wherein said arbitrator comprises a matrix comparer for determining whether a current transformation matrix approximate to said transformation matrix stored in said memory unit or not, if yes, said transformation matrix stored in said memory unit is valid and said coordinate transformation module is passed and the transformed geometry data stored in said memory unit is used to be a output data of said coordinate transformation module.

4. The computer graphics system according to claim 3, wherein said matrix comparer is a logical operator for performing a XOR operation on each element of said transformation matrix stored in said memory unit and each element of said current transformation matrix, and performing a OR operation on results of said XOR operation, and said transformation matrix stored in said memory equals to said current transformation matrix if the result of said OR operation is equal to zero.

5. The computer graphics system according to claim 1, wherein said graphics data computing unit has a lighting computing module for computing a lighted data corresponding to said geometry data and said lighted data as said intermediate data.

6. The computer graphics system according to claim 5, wherein said arbitrator includes a light vector computing unit for computing a light vector between a light source and a representative vertex.

7. The computer graphics system according to claim 6, wherein said arbitrator includes a light vector comparer for determining whether the current light vector approximates said light vector stored in said memory unit or not, if yes, said light vector stored in said memory unit is valid and the operation of said lighting computing module can be bypassed, and the lighted data stored in said memory unit is used to be the output data of said light vector computing unit.

8. The computer graphics system according to claim 7, wherein said light vector comparer is for performing a XOR operation on the current light vector and the light vector stored in said memory unit, and performing a OR operation on results of said XOR operation, the current light vector is equal to the light vector stored in said memory unit if the result of said OR operation is equal to zero.

9. The computer graphics system according to claim 1, wherein said memory unit includes a decoder for decoding a DCT transformed color data to load a pre-computed light data

10. The computer graphics system according to claim 1, wherein said arbitrator includes a image filter for filtering a re-rendered image area and outputting an updated pixel data in an updated image area of said re-rendered image area.

11. A method of computer graphics, comprising steps of:
receiving a geometry data and a rendering parameter for generating at least one a intermediate data and outputting at least one pixel corresponding to said geometry data;
Storing said intermediate data and said rendering parameter in a memory unit; and
Using an arbitrator for determining whether currently to-be-computed intermediate data can be replaced by said intermediate data stored in said memory unit.

12. The method according to claim 11, wherein said rendering parameter includes a transformation matrix.

13. The method according to claim 12, further comprising a step of using a coordinate transformation matrix to transform said geometry data to a transformed geometry data as said intermediate data based on said transformation matrix.

14. The method according to claim 13, wherein said arbitrator comprises a matrix comparer for determining whether a current transformation matrix approximate to said transformation matrix stored in said memory unit or not, if yes, said transformation matrix stored in said memory unit is valid and said coordinate transformation module is bypassed and said transformed geometry data stored in said memory unit is used to be the output of said coordinate transformation module.

15. The method according to claim 14, wherein said matrix comparer is a logical operator for performing a XOR operation on said transformation matrix stored in said memory unit and said current transformation matrix, and performing an OR operation on results of said XOR operation, and said transformation matrix stored in said memory equals to said current transformation matrix if the result of said OR operation is equal to zero.

16. The method according to claim 11, further comprising a step of using a lighting computing module for computing a lighted data corresponding to said geometry data and said lighted data as said intermediate data.

17. The method according to claim 16, wherein said arbitrator includes a light vector computing unit for computing a light vector between a light source and a representative vertex.

18. The method according to claim 17, wherein said arbitrator includes a light vector comparer for determining whether an inputted light vector approximates said light vector stored in said memory unit or not, if yes, said light vector stored in said memory unit is valid so that the operation of said lighting computing module is bypassed and said lighted data stored in said memory unit is used to be the output of said lighting computing module.

19. The method according to claim 18, wherein said light vector comparer is for performing a XOR operation on said inputted light vector and said light vector stored in said memory unit, and performing a OR operation on results of said XOR operation, the inputted light vector equals to the light vector stored in said memory unit if the result of OR operation is equal to zero.
